(19) United States
(12) Patent Application Publication
(10) Pub. No.: US 2007/0056577 A1
(43) Pub. Date: Mar. 15, 2007

(54) Barbecuing device

(76) Inventor: David Chang, Arcadia, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/517,841

(22) Filed: Sep. 7, 2006

(30) Foreign Application Priority Data
Sep. 9, 2005 (CN) 200520118496.9

(51) Int. Cl. A47J 37/00

(52) U.S. Cl. 126/25 R

(57) ABSTRACT

A device for barbequing food, said device including: a cabinet for storing a power source; a burner connectable to said power source for cooking said food, and a means for steam cleaning said device.

### CROSS-REFERENCES TO RELATED APPLICATIONS

This application claims priority to Chinese Patent Application No. 200520118496.9, filed Sep. 9, 2005, commonly assigned, incorporated by reference herein for all purposes.

### BACKGROUND OF THE INVENTION

The present invention relates to a barbecuing device.

Any discussion of the prior art throughout the specification should in no way be considered as an admission that such prior art is widely known or forms part of common general knowledge in the field.

Throughout this specification, the terms “barbeque”, “barbecuing”, and variants thereof mean a method of cooking food with the heat and hot gases of a fire, smoking wood, or hot coals and the like, and includes both indirect and direct methods of such cooking.

Occidentals usually prefer to barbecue food with a gas barbecuing device, which is typically a movable cooking apparatus having a movable cabinet, which contains one or more gas tanks, and a gas-powered burner. The burner is located below an upper cover of the movable cabinet, and food is barbequed on a grill plate over the gas-powered burner. When such a gas-powered burner is used to barbecue meat foodstuffs, a significant amount of grease is produced. This excess grease adversely affects the sanitary condition of the food and has an unfavorable effect on the normal use of the gas-powered burner. It is also frequently difficult to remove this grease from the surfaces of the device. It is also inconvenient to use this gas barbequing device because some types of food need to be turned frequently by hand so as to be cooked uniformly.

### BRIEF SUMMARY OF THE INVENTION

It is an object of the present invention to overcome or ameliorate at least one of the disadvantages of the prior art, or to provide a useful alternative.

An object of the present invention in at least one preferred form is to provide a barbequing device which provides a convenient means of cleaning the device, especially by removing grease. It is an object of the present invention in at least one preferred form to provide a barbequing device that automatically cooks food uniformly. An object of the present invention in at least one preferred form is to provide a barbecue device that provides automatic control over the temperature in the grill, fuel ignition, and safety measures of the device.

The present invention provides a device for barbequing food, said device including:
a cabinet for storing a power source;
a burner connectable to said power source for cooking said food, and
a means for steam cleaning said device.

Preferably, the steam cleaning means includes a steam generator and a device for delivering the steam fluidly connected to the steam generator. Preferably, the steam delivery device includes a discharge nozzle for discharging the steam and a trigger for actuating the steam delivery device. Preferably, the steam delivery device discharges pressurized steam to clean the outer surfaces of the burner and the barbequing device. Preferably, the steam delivery device is a steam blowgun.

Preferably, the steam generator includes a steam boiler storable in the cabinet. Preferably, the steam generator is connectable to the power source.

Preferably, the device includes a food grilling support for supporting one or more food grilling elements, wherein the food grilling elements are rotatable relative to the support to uniformly expose said food to the heat from said burner. Preferably, the food grilling support is arranged adjacent the burner. Preferably, the food grilling support includes holders for retaining the food grilling elements adjacent the burner, said holders being rotatable relative to the food grilling support. Preferably, the holders are rotationally driven by a transmission means.

Preferably, the transmission means includes one or more transmission shafts drivable by a motor. Preferably, each transmission shaft includes a transmission coupling for rotating a respective holder. In one embodiment, the holders are integrally formed with the transmission couplings for receiving respective ends of the food grilling elements. Preferably, the holders are axially aligned bores formed in the transmission shafts. Preferably, the bores have a shape complementary to the ends of the food grilling elements to securely hold the food grilling elements so that the food grilling elements rotate with the transmission shafts.

Preferably, the food grilling support includes a bracket for supporting an opposite end of each food grilling element, such that each food grilling element suspends food above the burner. Preferably, the bracket includes positioning means for securely holding the food grilling elements on the bracket. Preferably, the positioning means include notches in the bracket.

Preferably, the food grilling elements are skewers for removably holding food. Preferably, the skewers are removably connectable to the holders. Preferably, the skewers include means for retaining the skewers to the holders.

Preferably, the motor is an electric motor. Preferably, the electric motor is connected to an electrical power source. The electrical power source preferably includes a thermoelectric generator, solar cells, a steam driven generator or built-in fuel cells. Preferably, the electric power source is connectable to an accumulator by a charging circuit. Preferably, the electric motor is connected to the accumulator.

Preferably, thermoelectric generators are provided on inner and outer surfaces of the device adjacent the burner to maximize the temperature differential between the inner and outer surfaces and increase the efficiency of the thermoelectric generators. In one embodiment, the thermoelectric generators are provided on the inner and outer surfaces of a cover of the cabinet.

Preferably, solar cells are provided on the outer surfaces of the device. In one embodiment, the solar cells are provided at the rear and top of the device.

Preferably, the device includes a control circuit for controlling the temperature in the burner, a gas-igniting circuit, and a safety-guarding circuit, and a steam controlling circuit, wherein said control circuit and said steam controlling circuit are connected to the power source and are equipped with control switches arranged on the device.

Preferably, the burner includes a gas-powered jet burner. Preferably, the power source is a gas supply.

Preferably, the cabinet is movable. Preferably, the cabinet includes wheels.

A particularly preferred embodiment provides a barbeque device that is easily cleanable and provides an automated rotary grill for cooking food uniformly. In this embodiment of the barbecuing device of the present invention, steam cleaning of the barbecuing device is realized with the steam blowgun and food holding forks are rotationally driven by an electric motor to automatically grill food uniformly over the burner. At the same time, the temperature set-up in the grill, automatic firing, and flameout and gas leakage protection is achieved by a control circuit, which controls the temperature in the food grill area, a gas-igniting circuit and a safety-guarding circuit.

### BRIEF DESCRIPTION OF THE DRAWINGS

A preferred embodiment of the invention will now be described, by way of example only, with reference to the accompanying drawings in which:

FIG. 1 is a perspective view illustrating a barbecuing device of the present invention;

FIG. 2 is an exploded perspective view of a rotational grill support, in the barbecuing device of FIG. 1;

FIG. 3 is a schematic view of the gear transmission for the rotational grill support of FIG. 2;

FIG. 4 is a schematic view of an alternative gear transmission for the rotational grill support of FIG. 2;

FIG. 5 is a schematic drawing of a steam cleaning means used in the barbequing device of FIG. 1;

FIG. 6 is a schematic drawing of the rotational grill support of FIG. 2 in an operational state;

FIG. 7 is a schematic drawing of a food-holding fork for use in the rotational grill support of FIG. 2;

FIG. 8 is a schematic drawing of a different type of food-holding fork for use in the rotational grill support of FIG. 2;

FIG. 9 is a perspective view of the barbequing device of FIG. 1 illustrating the location of power sources;

FIG. 10 is a rear perspective view of the barbequing device of FIG. 1;

FIG. 11 is a schematic block diagram of the control circuit of the barbequing device of FIG. 1; and

FIG. 12 is a schematic block diagram of the safety mechanism used in the barbequing device of FIG. 1.

### DETAILED DESCRIPTION OF THE INVENTION

The device of the present invention will be further discussed hereinafter with reference to a preferred embodiment when considered in connection with the accompanying drawings.

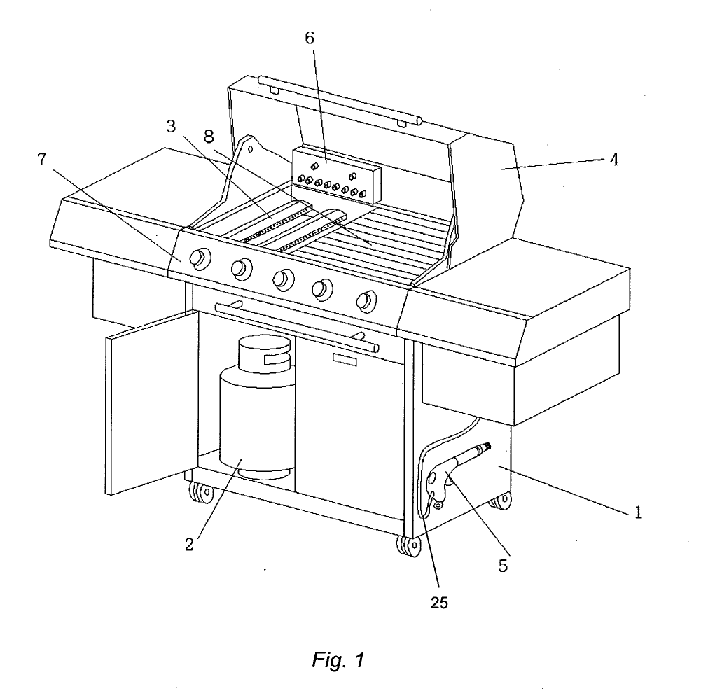

As shown in FIG. 1, the device for barbequing food includes a housing or cabinet 1 and a gas tank 2 located inside the cabinet 1. The cabinet includes mounted wheels so that the device is moveable, and thus portable for use in different locations. A gas-powered burner 3, which is supplied with gas from the gas tank 2, is mounted on the upper portion of the cabinet 1. The device also includes a cover 4 and a corrugated plate 8 located adjacent the gas burner 3. The corrugated plate 8 may be heated by the burner 3 or by another burner beneath the plate, to cook food. A rotational grill support 6 is provided at a position between the gas-powered burner 3 and the cover 4. A control panel 7 controls operation of the barbecuing device 1.

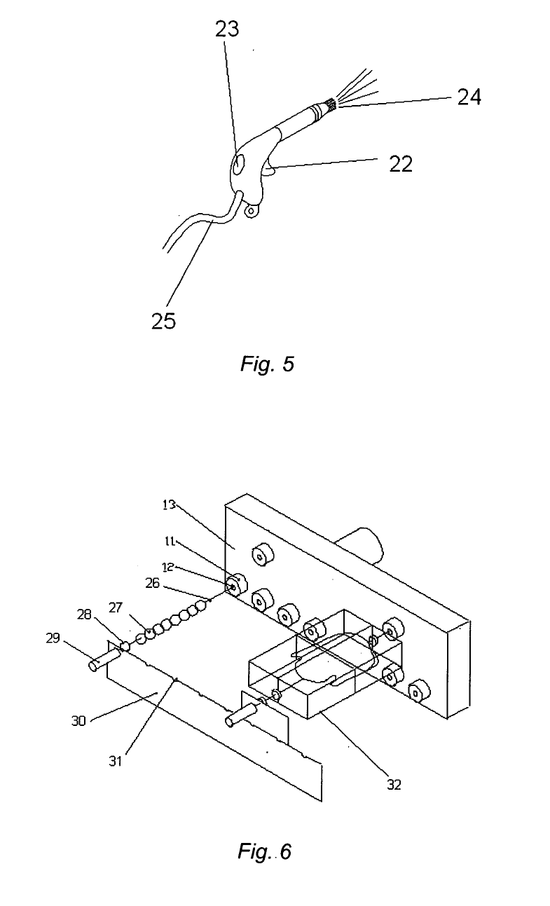

As shown in FIG. 1, a steam cleaning means in the form of a steam blowgun 5 is stowed to one side of the cabinet 1. A gas-type steam boiler (not shown) is stored within the cabinet 1, and is connected to the steam blowgun 5 by a conduit 25. As best shown in FIG. 5, the steam blowgun 5 includes a trigger 22 and a steam discharge nozzle 24. The blowgun 5 discharges pressurized steam to easily and conveniently remove any contaminants, such as grease, from the outer surface of the burner 3, plate 8, or any other surface of the barbequing device to which grease may have adhered during the barbequing of food.

The rotational grill support 6 includes a front casing 13 and a rear casing 13, containing a transmission means for rotating a plurality of food grilling elements in the form of food-holding skewers or forks 26. An electric gear motor 9 is connected to the rotational grill support 6 via the transmission means.

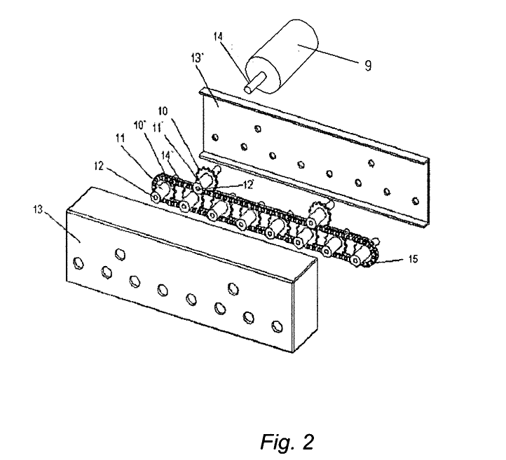

As shown in FIGS. 2 to 4 and 6, the transmission means includes two rows of transmission shafts 11, 11′ and transmission sprockets 10, 10′ securely fixed on the transmission shafts 11, 11′. A chain 15 is tensioned on the bottom row of transmission sprockets 10 and engages the top row of transmission sprockets 10′. A connection end 14′ of one transmission shaft 11 is coupled to an output shaft 14 of the gear motor 9. In this manner, the transmission shaft 11 is connected to the motor 9 to subsequently drive the transmission sprockets 10, 10′ via the chain 15. The transmission shafts 11, 11′ are formed with bores 12, 12′ that are axially aligned with the central longitudinal axes of their respective shafts 11, 11′. The bores 12, 12′ function as transmission couplings for directly receiving the ends of the food-holding forks 26 such that the forks 26 are removably coupled to the transmission shafts 11,11′. In an alternative embodiment, separate holders for the forks 26 can be provided for engagement with the bores 12, 12′, or the transmission shafts 11, 11′ directly.

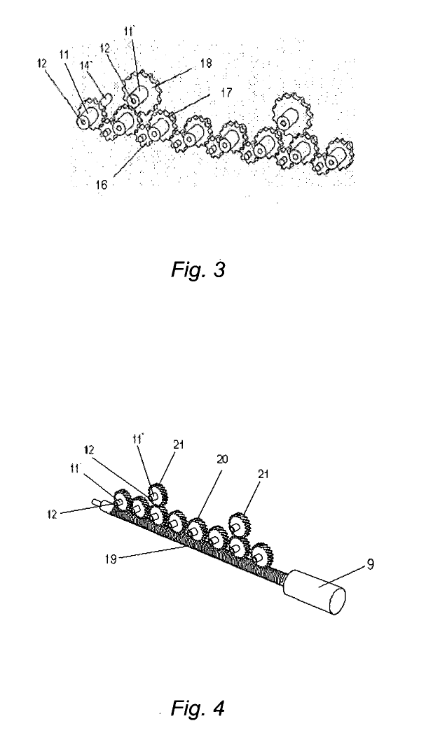

The front casing 13 and the casing 13′ of the grill support 6 also forms a gear case for the transmission gears of the transmission means. The casings 13, 13′ include through-holes corresponding to the relative positions of the transmission shafts 11, 11′ in the transmission means so that the transmission shafts 11, 11′ pass therethrough and form an integral shaft sleeve case. A set of transmission gears are mounted to the transmission shafts, with adjacent gears driven by intermediate gears. In the embodiment, gears 16, 17 and 18 are mounted to the transmission shafts 11, 11′ and constitute the gear transmission means for the rotational grill support 6, as best shown in FIG. 3. In an alternative embodiment, the gears 16 to 18 are replaced by a worm 19, and gears 20, 21 to form a worm-gear transmission means, as best shown in FIG. 4.

The rotational grill support 6 can hold the forks 26 in a cantilevered manner. However, it is preferable that the forks 26 are supported at both ends, and a bracket 30 is provided opposite the case 13, 13′ for this purpose. The bracket 30 includes a series of indentations or notches 31 for locating respective ends of the food holding forks 26.

As shown in FIG. 6, each food-holding fork 26 is a straight, cylindrical rod that is releasably secured to the transmission shaft 11 at one end and is supported by the bracket 30 at its other end, such that it can rotate relative to the bracket 30 and the front case 13 above the gas burner 3. In order to securely locate the food-holding fork 26, a locking nut 28 is provided on the food-holding fork 26 to limit axial relative movement of the food-holding fork 26 to the bracket 30. A handle 29 is also provided on each food-holding fork 26 to facilitate installation of the forks 26 onto the grill support 6.

The front end of a food-holding fork 26 includes a lug, which has a regular polygon or a spade-like shape. The bores 12, 12′ in the transmission shafts 11, 11′ are formed with a complementary shape and size to the lugs of the food-holding forks 26, such that food-holding forks 26 fit snugly within the holes 12, 12′ and are securely retained therein. Thus, the transmission shafts 11, 11′ and the food-holding forks 26 are locked together and rotate as a single body, and enabling the uniform cooking of food skewered by the forks 26 over the burner 3.

The food-holding forks 26 may be directly inserted into food objects 27, such as small meats. A steel cage 32 may be releasably secured to the food-holding forks 26 so that large and soft food, such as fish, may be placed within the cage 32 for barbequing. The space between the transmission shafts 11′ in the top row is relatively large, suitable for barbecuing large food pieces, whereas the space between the transmission shafts 11 in the bottom row is smaller, suitable for barbequing small food pieces.

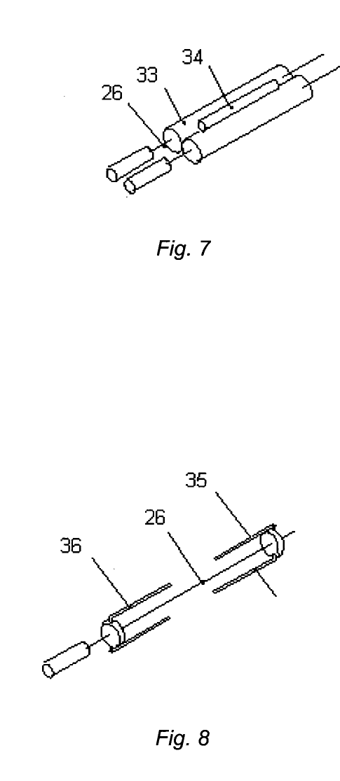

As shown in FIG. 7, the middle portion of a food-holding fork 26 may be configured to include a round roller 33 to increase the effective diameter of the food-holding fork 26. This permits long foods 34, such as hot-dog sausages, to be placed between two forks 26 and supported by their respective round rollers 33 for simultaneous rotation with the round rollers 33.

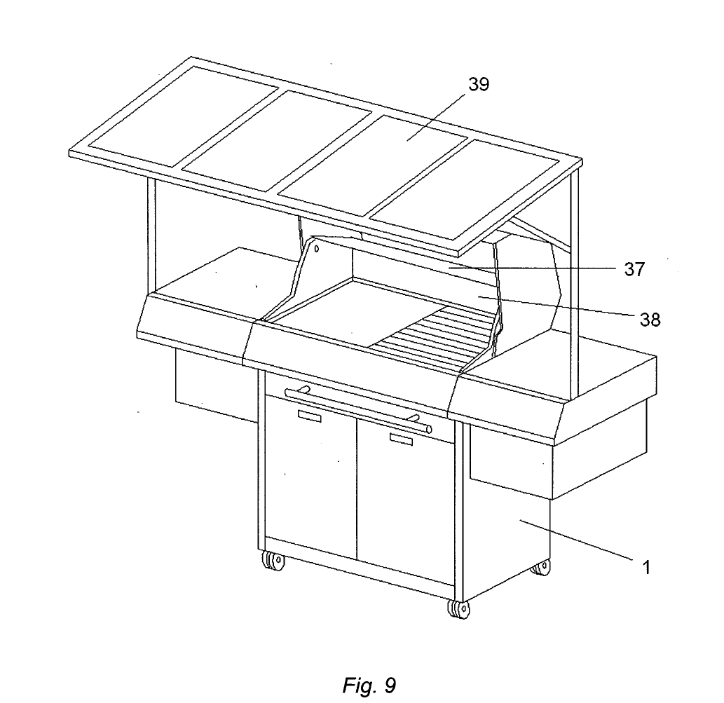

As shown in FIG. 8, two flexible arms 35 and 36 may be symmetrically fixed at either end of the food-holding fork 26. The flexible arms 35 and 36 clamp large pieces of food, such as whole chickens, duck and other poultry, so that these foods can rotate together with the food-holding fork 26 for barbequing above the gas burner 3.

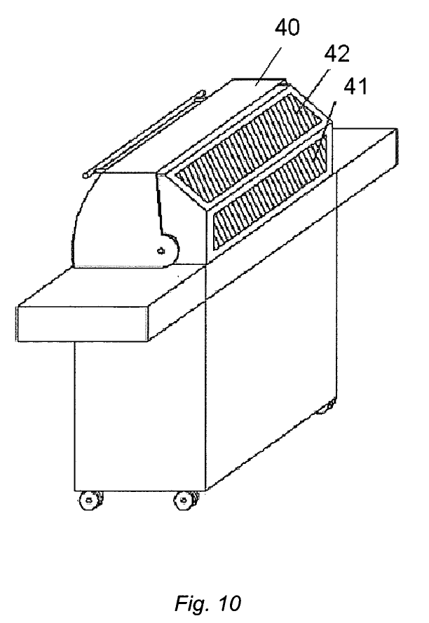

The barbecuing device according to the preferred embodiment of the present invention also uses a variety of electrical power sources, including a thermoelectric generator 37, 38, solar cells 39, 40, 41, 42, steam generator 43 and fuel cell 44. One ore more of these electric power sources can be used as the energy source for the burner 3 and for driving the rotational grill support 6. The solar cells, thermoelectric generator, steam generator and fuel cells may be easily employed in the device using conventional techniques. For example, and as shown in FIG. 9, several thermoelectric generators 37, 38 are arranged on the inner and outer surfaces of the cover 4 of the cabinet 1. Since the cover 4 is in relatively close proximity to the gas burner 3, the temperature differential is maximized between the inner and outer surfaces of the cover, thus increasing the efficiency of the thermoelectric generators 37, 38. Solar cells 39, 40, 41 and 42 can be located on the outer surfaces of the device as an additional or alternative energy source, as best shown in FIGS. 9 and 10.

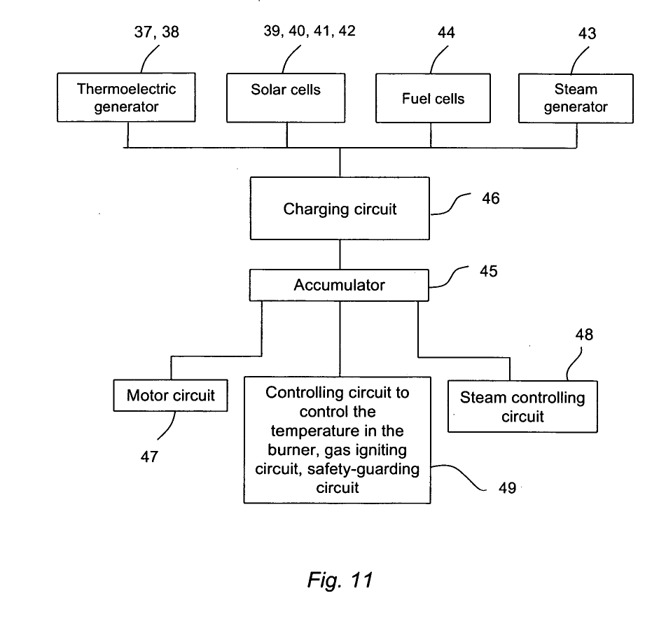

These power sources are connected to an accumulator 45 through a charging circuit 46, as best shown in FIG. 11. The accumulator is located inside the cabinet 1, and a motor circuit 47 and a steam controlling circuit 48 are also connected to the accumulator 45 and the charging circuit 46 to access these power sources. The barbecuing device 1 is also provided with a control circuit 49 which controls the temperature in the grill, a gas igniting circuit and a safety-guarding circuit. The control circuit, gas igniting circuit and safety-guarding circuit are also connected to the power sources through the accumulator 45.

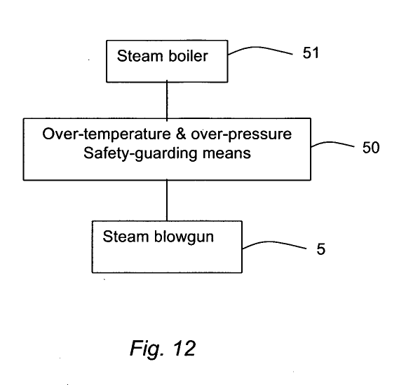

FIG. 12 shows a safety mechanism for the device, where a safety guard means (typically a circuit 50) monitors the temperature and pressure within the steam boiler 51 to ensure that the steam discharged from the steam blowgun 5 does not exceed preset levels of temperature and pressure when cleaning the device, protecting the user from harm and the device from damage.

Thus, the preferred embodiment of the invention provides a barbecuing device where grease and other contaminants can be cleaned easily and very conveniently with the steam blowguns. Furthermore. The rotational grill support 6 provides an automated means for cooking food uniformly over the gas burner 3.

Electric power is used as the energy source for the whole device and the gas tank can be accommodated the cabinet, so the device is particularly suitable for mobile outdoor barbecues without being restricted by the availability of outdoor electric power.

The above preferred embodiment has been described in an illustrative manner, and should be not understood as a limitation to the present invention. Any products identical or similar to the present invention in light of this invention fall within the scope of the present invention.

What is claimed is:

1. A device for barbequing food, said device including:
a cabinet for storing a power source;
a burner connectable to said power source for cooking said food, and
a means for steam cleaning said device.

2. The barbequing device of claim 1, wherein the steam cleaning means includes a steam generator and a device for delivering the steam fluidly connected to the steam generator.

3. The barbequing device of claim 2, wherein the steam delivery device includes a discharge nozzle for discharging the steam and a trigger for actuating the steam delivery device.

4. The barbequing device of claim 2, wherein the steam delivery device discharges pressurized steam to clean the outer surfaces of the burner and the barbequing device.

5. The barbequing device of claim 4, wherein the steam delivery device is a steam blowgun.

6. The barbequing device of claim 2, wherein the steam generator is connectable to the power source.

7. The barbequing device of claim 6, wherein the steam generator includes a steam boiler storable in the cabinet.

8. The barbequing device of claim 1, further including a food grilling support for supporting one or more food grilling elements, wherein the food grilling elements are rotatable relative to the support to uniformly expose said food to the heat from said burner.

9. The barbequing device of claim 8, wherein the food grilling support includes holders for retaining the food grilling elements adjacent the burner, said holders being rotatable relative to the food grilling support.

10. The barbequing device of claim 9, wherein the holders are rotationally driven by a transmission means, the transmission means including one or more transmission shafts drivable by a motor.

11. The barbequing device of claim 10, wherein each transmission shaft includes a transmission coupling for rotating a respective holder.

12. The barbequing device of claim 11, wherein the holders are integrally formed with the transmission couplings for receiving respective ends of the food grilling elements.

13. The barbequing device of claim 12, the holders are axially aligned bores formed in the transmission shafts, the bores having shapes complementary to the ends of the food grilling elements for securely holding the food grilling elements so that the food grilling elements rotate with the transmission shafts.

14. The barbequing device of claim 8, wherein the food grilling support includes a bracket for supporting an opposite end of each food grilling element, such that each food grilling element is capable of suspending food above the burner.

15. The barbequing device of claim 14, wherein the bracket includes positioning means for securely holding the food grilling elements on the bracket.

16. The barbequing device of claim 10, wherein the motor is an electric motor connected to an electrical power source, the electrical power source including a thermoelectric generator, solar cells, a steam driven generator or built-in fuel cells.

17. The barbequing device of claim 16, wherein the electric power source is connectable to an accumulator by a charging circuit, and the electric motor is connectable to the accumulator.

18. The barbequing device of claim 1, wherein solar cells are provided on the outer surfaces of the device, or thermoelectric generators are provided on inner and outer surfaces of the device adjacent the burner to maximize the temperature differential between the inner and outer surfaces and increase the efficiency of the thermoelectric generators.

19. A barbequing device according to claim 1, further including a control circuit for controlling the temperature in the burner, a gas-igniting circuit and a safety-guarding circuit, and a steam controlling circuit, wherein said control circuit and said steam controlling circuit are connected to the power source and are equipped with control switches arranged on the device.
